(19) United States
(12) Patent Application Publication
(10) Pub. No.: US 2013/0056556 A1
(43) Pub. Date: Mar. 7, 2013

(54) NOZZLE HEAD FOR A SPRAY DEVICE

(71) Applicants: Ewald Schmon, Grafenberg (DE); Peter Dettlaff, Remseck (DE)

(72) Inventors: Ewald Schmon, Grafenberg (DE); Peter Dettlaff, Remseck (DE)

(73) Assignee: SATA GMBH. & CO. KG, Kornwestheim (DE)

(21) Appl. No.: 13/698,417

(22) PCT Filed: May 21, 2011
(86) PCT No.: PCT/EP2011/002544

§ 371 Date: Nov. 16, 2012

(30) Foreign Application Priority Data
May 28, 2010 (DE) 20 2010 007 355.3

(51) Int. Cl. B05B 1/28

(52) U.S. Cl. 239/296

(57) ABSTRACT

The invention relates to a nozzle head for a spray device, comprising a central material nozzle, an air ring nozzle surrounding said material nozzle, and preferably at least two laterally projecting horns, into each of which at least one horn air nozzle is incorporated, and optionally comprising a material-conducting needle, characterized in that at least one nozzle (3, 3a, 3b, 5, 5a, 12, 12a, 12b, 15, 16, 17, 17a, 17b, 17c, 18, 18a, 18b1, 18b2, 18b3, 300a, 300b), preferably at least one horn air nozzle (15, 16, 17, 17a, 17b, 18, 18a, 18b1, 18b2, 18b3, 300a), has a non-cylindrical shape.

The invention pertains to a nozzle head for a spray device according to the preamble of claim 1.

Such nozzle heads are commonly used on spray devices for the hydrostatic, pneumatic or combined hydrostatic and pneumatic atomization of paints, varnishes, adhesives or other liquid substances, particularly in paint spray guns.

In the nozzle heads of such spray devices, the air ring nozzle has the function of discharging the compressed air supplied to the device in the form of a high-energy air jet that draws material from another central nozzle, atomizes this material and forms a spray jet containing said material. Horn air nozzles usually are directed at the spray jet obliquely and equidirectionally to the outflow direction in laterally arranged horns of the nozzle head that point forward in the spray jet direction such that the air jets being discharged from these nozzles can respectively deform or form the spray jet. Due to the lateral deformation/formation, a more or less large flat jet or flat jet and round jet is created in dependence on the flow energy (air quantity, air pressure, flow speed, etc.).

In order to achieve an optimal work result, the spray jet needs to be adapted, among other things, with respect to the jet width, the material distribution, the material type and the droplet size. The adaptation is essentially carried out in dependence on the physical boundary conditions (supply air pressure, air quantity, etc.) in the form of a constructive adaptation of the openings of the central air ring nozzle and the horn air nozzles. In order to achieve sufficiently homogenous spray jets, one, two, three or more horn air nozzles that interact with the central opening of the central nozzle are typically used per horn. Paint spray guns with one, two or more horn air nozzles are known from practical applications and ensure a sufficient jet formation and atomization based on the criteria mutual distance, diameter, angle and distance from the paint nozzle opening, as well as the number thereof. In this case, the horn air nozzles are arranged in an air cap that is mounted on the paint spray gun body, usually screwed thereon by means of mounting rings. The central air nozzle may also be directly screwed, clipped or similarly mounted on the paint nozzle or on the paint spray gun body. A nozzle head of this type is known, for example, from German Utility Model G 90 01 265.8. The paint nozzle openings and the horn air nozzle openings are conventionally realized in the form of round bores.

In practical applications, the diameters of the horn air nozzles are realized differently depending on the supply pressure and the individually desired shape of the spray jet. The effect of the individual horn air nozzles is dependent on the supply pressure. Splitting of the jet may occur at higher supply pressures. An undesirably coarse atomization with small jet width may occur at excessively low supply pressures. In addition, the material throughput and other material properties (e.g., viscosity, rheology, etc.) are also highly dependent on the supply pressure and the arrangement of the horn air nozzles. When using one or more smaller horn air nozzles or unfavorable bore angles, back-misting problems may occasionally arise on the opening surfaces of the nozzles due to the suction effect occurring at smaller nozzle or bore diameters.

Small control openings or auxiliary atomizer openings that contribute to the jet formation and the atomization are usually arranged around the central nozzle. In order to transform the pre-formed jet emerging from the cylindrical tube of the central air nozzle opening into a different shape or, for example, to convert a round jet into a flat jet, large amounts of energy from the jet formation bores and the horn bores are required, which ultimately lead to high energy losses and limit the jet formation.

One significant disadvantage of this jet formation method can be seen in that a large part of the energy for the jet formation and the post-atomization is already blown out into the surrounding air through the narrow bores and multiple outlets (large shear planes on the surface in connection with significant fluctuations in speed).

Modified nozzle heads with possibly deviating spraying parameters and geometries frequently need to be used for slightly different paint or varnish materials in order to achieve a flawless spray pattern and therefore the desired result of the paint application, varnish application or other material application.

It is the objective of the invention to improve a nozzle head in such a way that the flow energy of the compressed air can be optimally converted into jet formation, flow speed and therefore into atomization work.

This objective is attained with a nozzle head with the characteristics of claim 1. Due to the formation of the central jet with the aid of at least one non-cylindrical nozzle, particularly at least one non-cylindrical horn air nozzle, it is also possible to significantly reduce the amount of energy required for the jet formation.

The invention is based on the fact that the required adaptation of cylindrical nozzles to the individual requirements can only be realized by varying the diameter sizes, the length and the inclination of the cylindrical bores, their mutual distance and the distance from the other nozzle openings. Non-cylindrical nozzles can be fluidically optimized and adapted to the individual task in an easier fashion.

It goes without saying that the internal shape, particularly the opening of the nozzles, should be non-cylindrical in this case. The external shape of the nozzles usually is unimportant for the jet formation.

Advantageous embodiments of the invention are disclosed in the remaining claims.

In an enhancement of the invention, a variable design of the control bores is proposed in order to achieve an efficient jet formation.

This applies analogously to the shaping of the flow regions of the air nozzle. Consequently, the round jet can be pre-formed due to a special shaping in such a way that less horn air is required for the formation of the broad jet and arbitrary jet shapes can be realized.

It is proposed, in particular, to utilize nozzles with an elliptical or at least approximately oblong hole-shaped cross section.

The atomization process can be additionally improved with a nozzle opening that widens in the direction of the spray jet.

It is also possible to provide grooves, lamellae, air guide vanes or the like in order to guide the air in the nozzle openings.

The non-cylindrical nozzles may be produced in metallic parts by means of machining. The non-cylindrical nozzles can be manufactured in a particularly simple fashion from plastic, particularly from a plastic that can be injection-molded. Such nozzles may likewise be realized in plastic inserts and mounted in nozzle heads of metal.

In addition, other advantageous effects can be achieved due to the combination of cylindrical, conical and other non-cylindrical nozzle openings.

Other advantageous details and embodiments of the invention are illustrated in the figures described below.

In these figures:

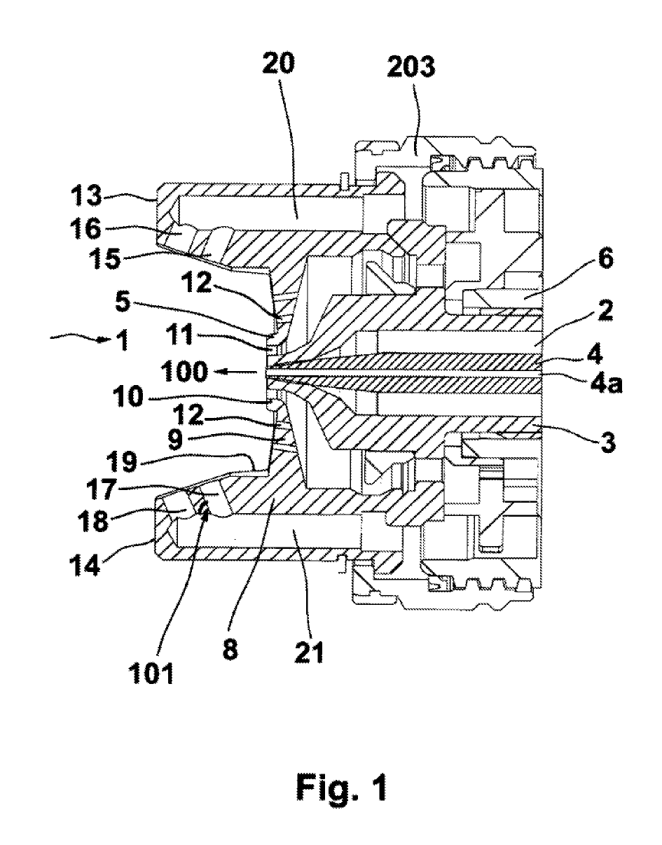

FIG. 1 shows a section through a first exemplary embodiment of a nozzle head,

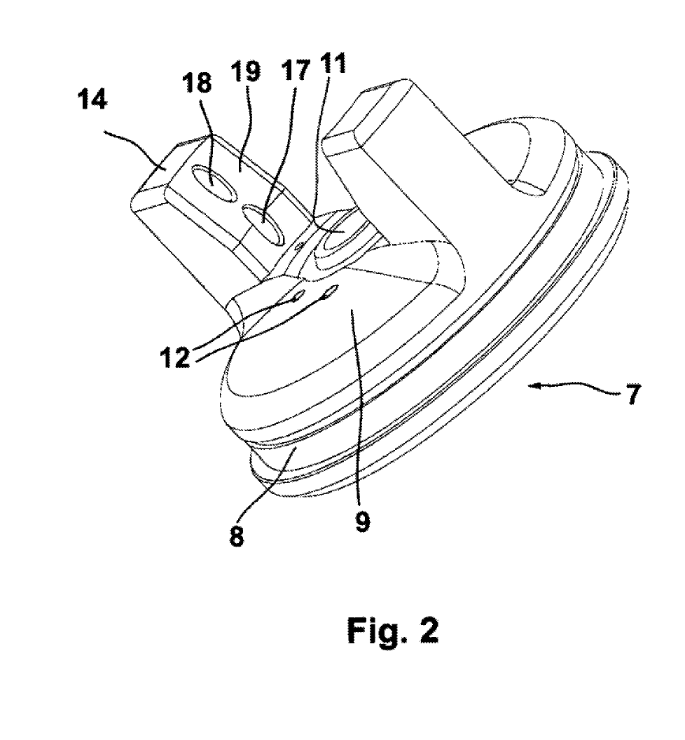

FIG. 2 shows a top view of a portion of the nozzle head according to FIG. 1,

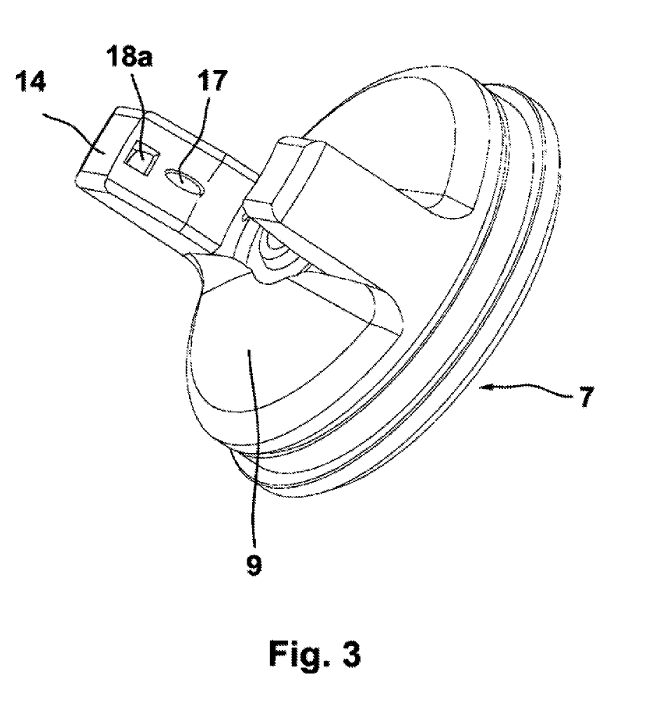

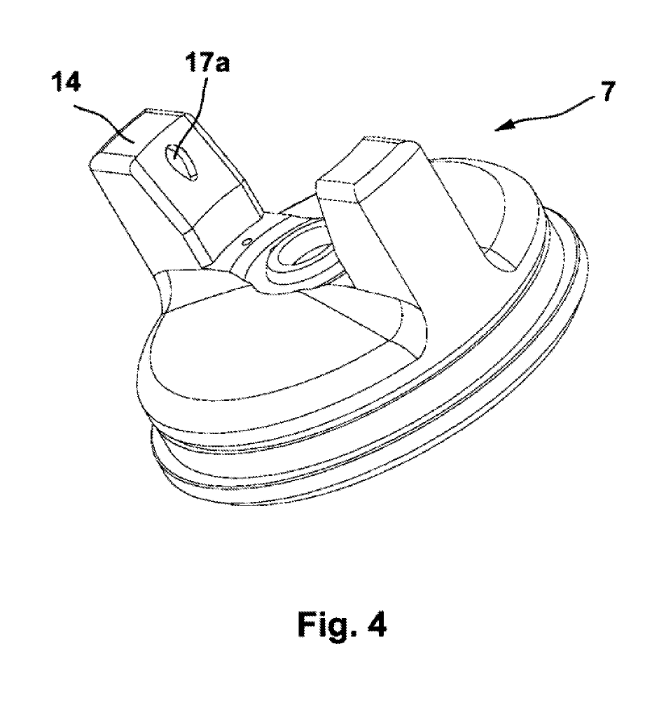

FIG. 3 shows a variant of FIG. 2,

FIGS. 4-8 and 11-14 respectively show a top view of miscellaneous variants of a portion of a nozzle head,

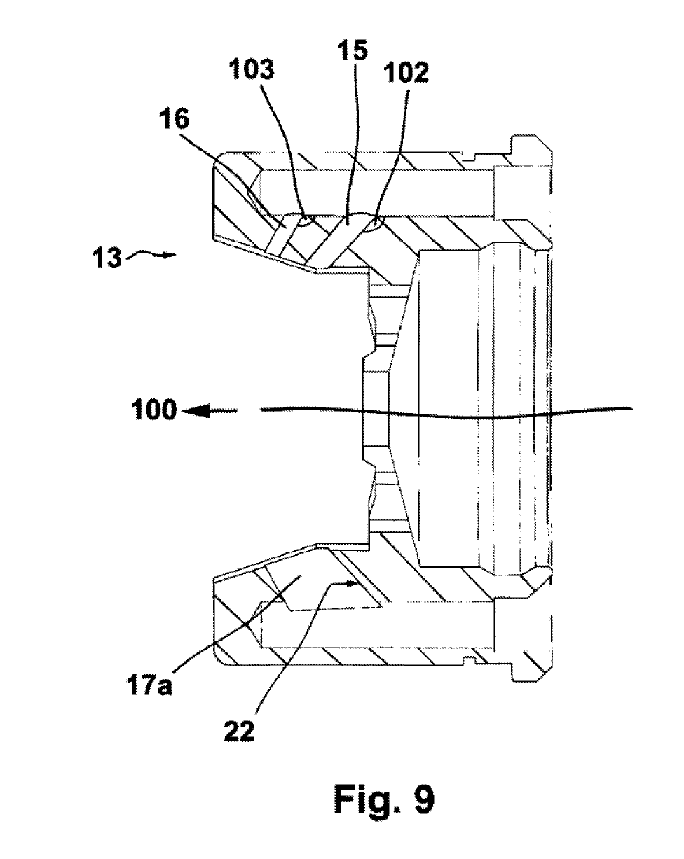

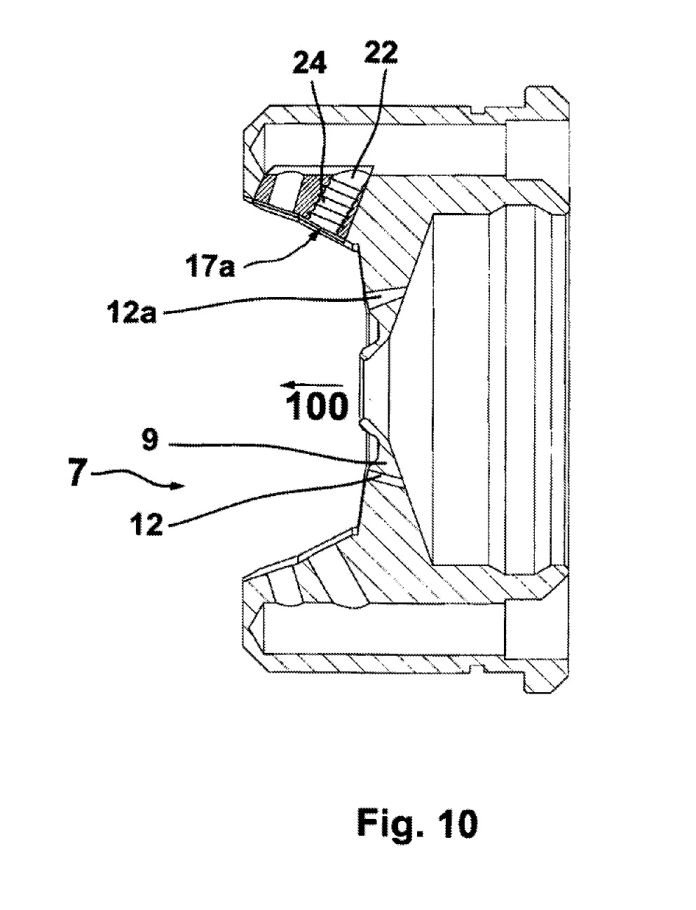

FIGS. 9 and 10 respectively show a sectional representation of a nozzle head, and

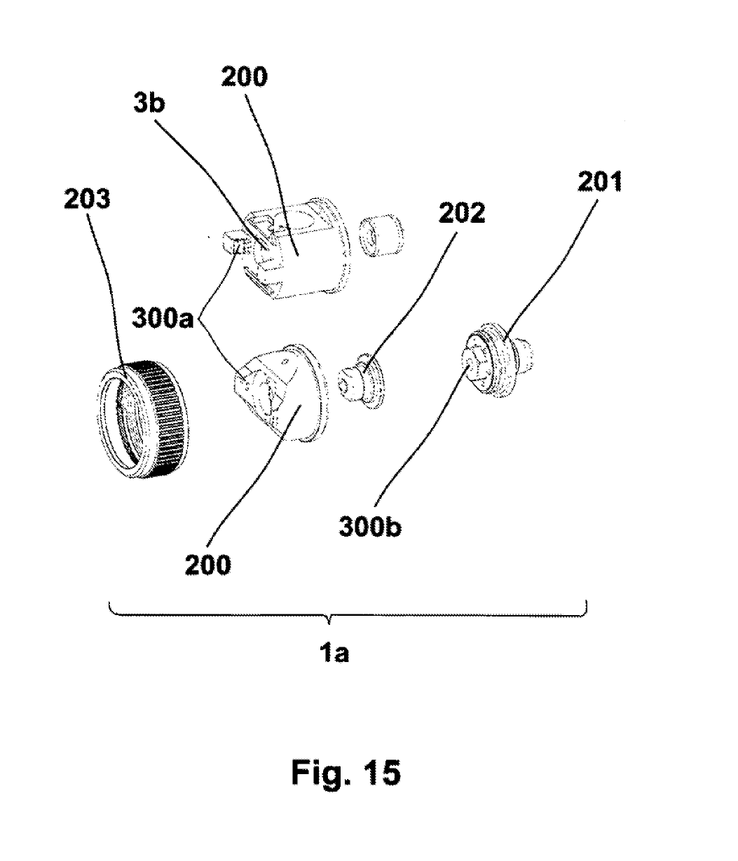

FIG. 15 shows an exploded view of another nozzle head.

The nozzle head for a paint spray gun illustrated in FIGS. 1 and 2 features a paint nozzle body 1 with an essentially cylindrical paint channel 2 that centrally opens into a paint nozzle 3. A hollow paint needle 4 is inserted into the paint nozzle 3. The paint nozzle 3 is surrounded by an air ring nozzle 5, to which air can be supplied via channels 6. An air cap 7 is screwed on the gun body by means of a ring 203 that is usually referred to as [an] air nozzle ring. However, the air cap 7 could also be mounted on the gun body in a different way. In the present exemplary embodiment, the air cap 7 is injection-molded of plastic. It features an annular section 8 that suitably adjoins the gun body. This annular section 8 is followed by an essentially plane cover plate 9. In a so-called opening area, the cover plate 9 features an annular elevation 10 that protrudes over this plane area 9 and into which an opening 11 is centrally recessed. When the paint nozzle 3 is installed, the opening 11 extends around this paint nozzle and therefore around the air ring nozzle 5. Continuous control nozzles or control openings 12 are provided at several locations in the cover plate 9 laterally of the opening 11. The control nozzle openings 12 are aligned at an angle of approximately 20 degrees referred to the spray jet direction 100. At two opposite locations, the air cap 7 respectively features a horn 13 or 14 that extends forward in the spray jet direction 100. In the present exemplary embodiment, the horns 13, 14 are respectively realized in the form of a body of rectangular cross section that is closed on the top. Each horn 13, 14 respectively features two horn air nozzles 15, 16 and 17, 18 that are arranged behind one another in the spray jet direction 100 and extend through the inner wall 19 of the horns 13, 14. The horn air nozzles 15, 16, 17, 18 are obliquely aligned in the direction of the spray jet 100. In the present example, both horn air nozzles 15, 16 and 17, 18 of each horn 13 and 14 essentially extend parallel to one another at an angle 101 of approximately 140 degrees referred to the spray jet direction 100. However, the horn air nozzles 15, 16 may also be aligned at an angle relative to one another or against one another. They can be supplied with compressed air via one respective air channel 20 or 21 that extends through the respective horn 13 or 14 in the longitudinal direction. The high-energy annular air jet being discharged from the air ring nozzle 5 draws the paint from the paint nozzle 3, wherein a round jet is formed and discharged in the spray jet direction 100. The horn air jets being discharged from the horn air nozzles 15, 16 and 17, 18 are directed at the round jet, flow obliquely and equidirectionally to the spray jet direction 100 and deform the round jet into the desired broad jet.

The horn air nozzles 15, 16 and 17, 18 are fluidically optimized in such a way that the round jet is subjected to a homogenous jet formation and the desired jet width is achieved without splitting the spray jet. According to FIG. 2, both horn air nozzles 17, 18 of the horn 14 have an elliptical cross section and have the same size. In the present exemplary embodiment, the small curvatures of the ellipses respectively lie on the top and on the bottom. However, the ellipses could also be arranged transverse to the longitudinal direction of the respective horn 14 or 13. Combinations of such ellipses are also conceivable. This special design of the horn air nozzles 17, 18 could be realized without any problems by injection-molding the air cap 7. In this case, it is not absolutely imperative to provide a separate air cap 7; the nozzle head 1 could also be realized differently (in one piece). In the context of the invention, the non-cylindrical nozzles in the nozzle head are of essential importance.

In the present exemplary embodiment, the paint needle 4 is hollow and features an opening 4a that is realized cylindrically along its longitudinal axis and through which a vacuum or an overpressure can be generated in the spray jet. In one particular variant, another varnish component is injected into the spray jet via the hollow needle 4. For this purpose, the inlet opening of the needle 4 is connected to corresponding material-containing devices. In a special embodiment, the opening 4a may be realized non-cylindrically such as, e.g., with an oval cross section or with any other non-cylindrical shape.

The opening 4a may be connected to compressed air or to a vacuum.

On the other hand, the paint needle 4 may also be realized in the form of a solid body rather than in a hollow fashion. In this case, the needle 4 advantageously is always realized such that its external shape corresponds to the internal shape of the paint nozzle 3 at the sealing point or contact surface with this nozzle and sealing pairings are realized.

In the variant according to FIG. 3, the first horn air nozzle 17 referred to the spray jet direction 100 is realized with an elliptical cross section while the next horn air nozzle 18a is realized with a square cross section. A rectangular shape would also be conceivable. The horn air nozzle 18a is smaller than the horn air nozzle 17 in this case. No control openings are provided in this exemplary embodiment. However, they could also be provided in this case. This also applies analogously to the embodiments described below.

FIG. 4 shows an air cap 7 for a nozzle head, on which only a single horn air nozzle 17a is provided per horn. This horn air nozzle 17a is shaped in a drop-shaped oval fashion, wherein the greater curvature of the oval is arranged in the upper region of the horn 14 in a top view of the inner wall 19 of the horn 14.

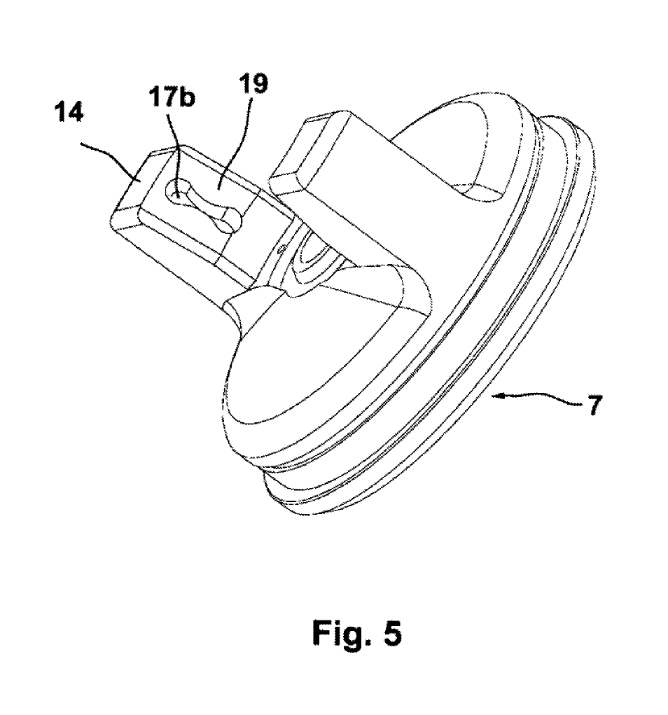

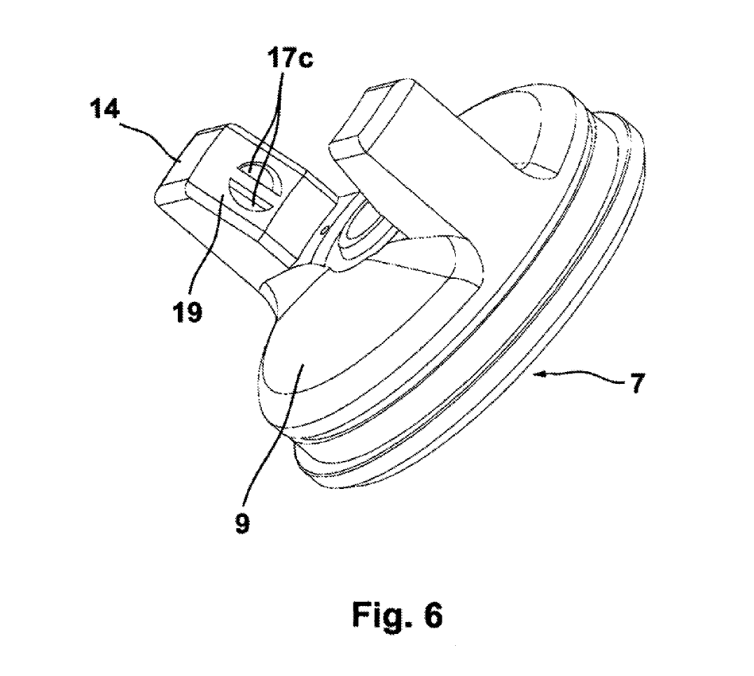

In the variant illustrated in FIG. 5, only a single horn air nozzle 17b is likewise provided per horn. In this case, the shape of the horn air nozzle 17b is realized in such a way that approximately the contour of the number 8 is visible in a top view of the inner wall 19 of the horn 14.

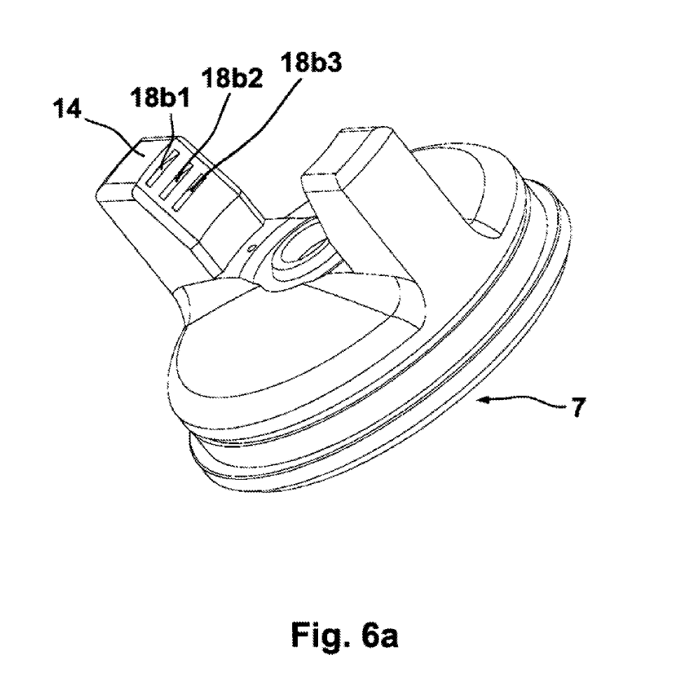

FIG. 6 shows a variant similar to that illustrated in FIG. 5. In the air cap 7, the horn air nozzle 17b according to FIG. 5 effectively is longitudinally divided into a two-part horn air nozzle 17c in this case. The two parts of the horn air nozzle 17c are realized in an approximately lunulate fashion. In the embodiment shown, the curvatures are directed outward. However, a reversed arrangement would likewise be conceivable. It is also possible to respectively align the curvatures of the crescents toward the top and the bottom.

In the variant according to FIG. 6a, three horn air nozzles 18b1, 18b2, 18b3 of rectangular cross section are provided in the horn 14 of the air cap 7.

The horn air nozzles described so far have the same internal size anywhere in the longitudinal direction. However, it is also possible to utilize horn air nozzles that are widened or tapered in the longitudinal direction.

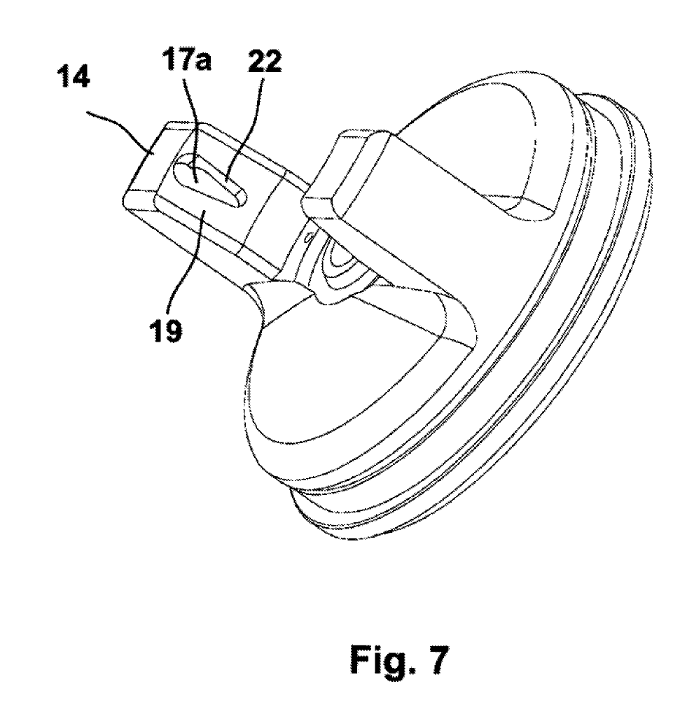

FIG. 7 shows a variant, in which the horn air nozzle 17d that has an elliptical shape in a top view respectively widens toward the top or in the longitudinal direction along its longitudinal extent through the inner wall 19 of the horn 14. In this case, the flow surface 22 of the horn air nozzle 17d is realized in a smooth fashion.

The flow surface 22 of the horn air nozzle 17d or another horn air nozzle could also have a corrugated, nubby, fluted or spiral-shaped design or be realized in a different way.

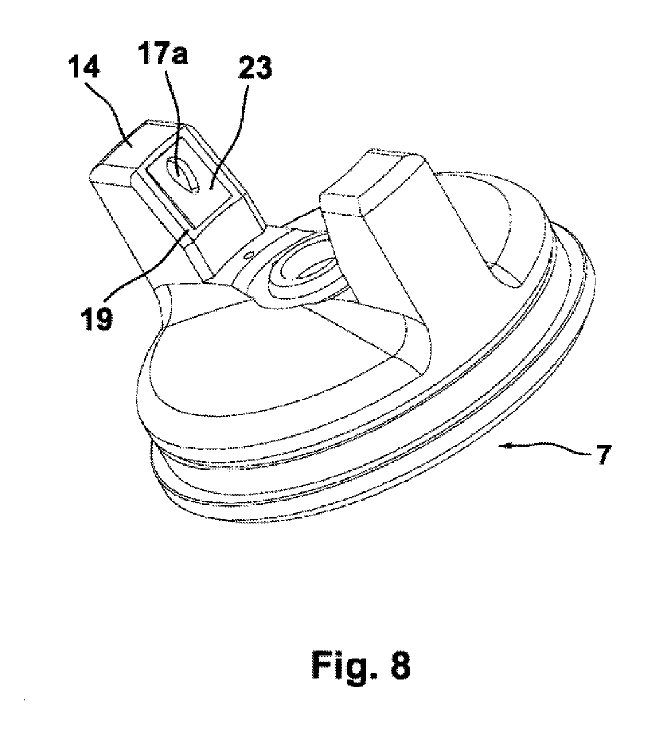

In the variant according to FIG. 8, the same horn air nozzle 17a as in FIG. 4 is provided on the air cap 7. However, the horn air nozzle 17a was not manufactured together with the air cap 7 in this case, but rather recessed from a plastic body 23 in the form of a continuous opening, wherein said plastic body is inserted, particularly clipped, into a continuous opening in the inner wall 19 of the horn 14 in a precisely fitted fashion. In the present example, the insert is realized with a rectangular contour—like the opening in the inner wall 19 of the horn 14. The insert and the opening for the horn air nozzle 17a or another horn air nozzle naturally may also be realized differently; these details are not particularly important for the function of the inventive nozzle head. Thusly shaped openings for accommodating nozzles not only can be produced without any problems on air caps of plastic, but basically also on air caps of metal such as, for example, steel (e.g., manganese steel).

The insert 23 could also be bonded into the opening in the sidewall 19 of the horn 14.

A variant of FIG. 1 is illustrated in the upper half of FIG. 9; identical components are identified by the same reference symbols. In contrast to FIG. 1, the two horn air nozzles 15, 16 of the horn 13 extend at different angles referred to the spray jet direction 100. The angle 102 of the horn air nozzle 15 amounts to approximately 130 degrees while the angle 103 of the horn air nozzle 16 amounts to approximately 120 degrees.

A variant of a portion of the embodiment according to FIG. 4 is illustrated in the lower half of the sectional representation in FIG. 9. This figure clearly shows that the flow surface 22 of the horn air nozzle 17a is realized in a smooth fashion in the vertical direction of the horn air nozzle 17a or in the spray jet direction 100.

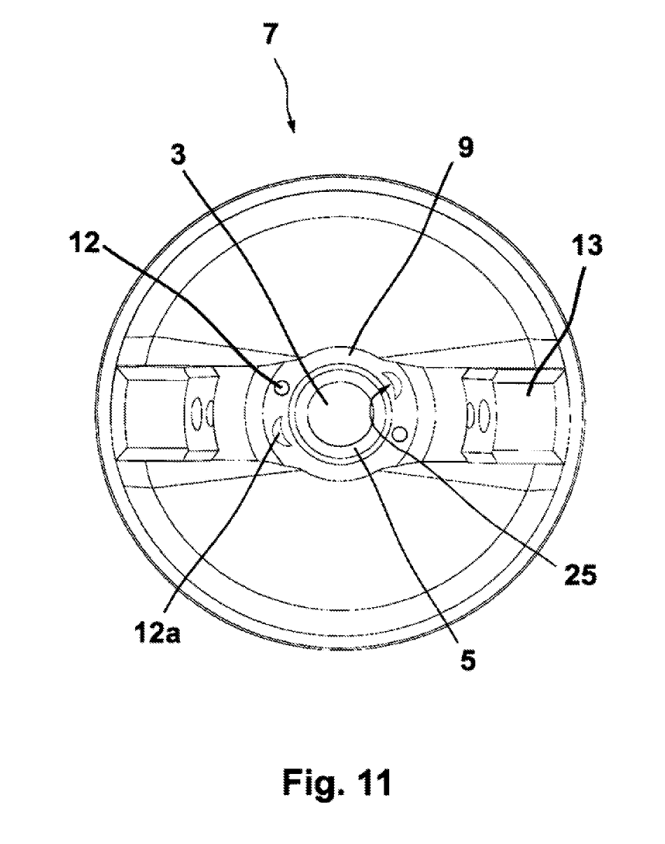

FIG. 10 shows a variant of FIG. 8 and FIG. 4. This figure clearly shows that the flow surface 22 of the horn air nozzle 17a may also be realized in a transversely fluted fashion in the vertical direction of this horn air nozzle 17a and feature a plurality of flow-conveying grooves 24 for the horn air. The grooves 24 may be realized in the form of longitudinal grooves in another embodiment. Furthermore, control openings or control nozzle openings 12, 12a are also provided in this case. The control nozzle openings 12, 12a are aligned at an angle referred to the spray jet direction 100. A few control openings or control nozzle openings 12a provided in the cover plate 9 of the air cap 7 are not conventionally realized cylindrically, but rather with a diameter that conically widens in the spray jet direction 100. In a top view, the control nozzle openings 12a are realized in an approximately lunulate fashion as illustrated in FIG. 11. The inner curvature of each crescent 12 points toward the air ring nozzle 5 or toward the paint nozzle opening 3 in this case. One, two or more control nozzle openings may be provided per side and realized with arbitrary cross sections; the invention is not limited in the number of control nozzle openings. In the present exemplary embodiment, four control nozzle openings 12 and 12a are provided in pairs in areas of the cover plate 9 of the air nozzle 7 that lie adjacent to the horns 12, 13. In this case, a cylindrical control nozzle opening 12 respectively lies adjacent to a non-cylindrical control nozzle opening 12a. However, it would also be conceivable to provide only non-cylindrical or only cylindrical control nozzle openings.

It would also be possible to provide lamellae, nubs or the like instead of the transverse grooves 24 or longitudinal grooves.

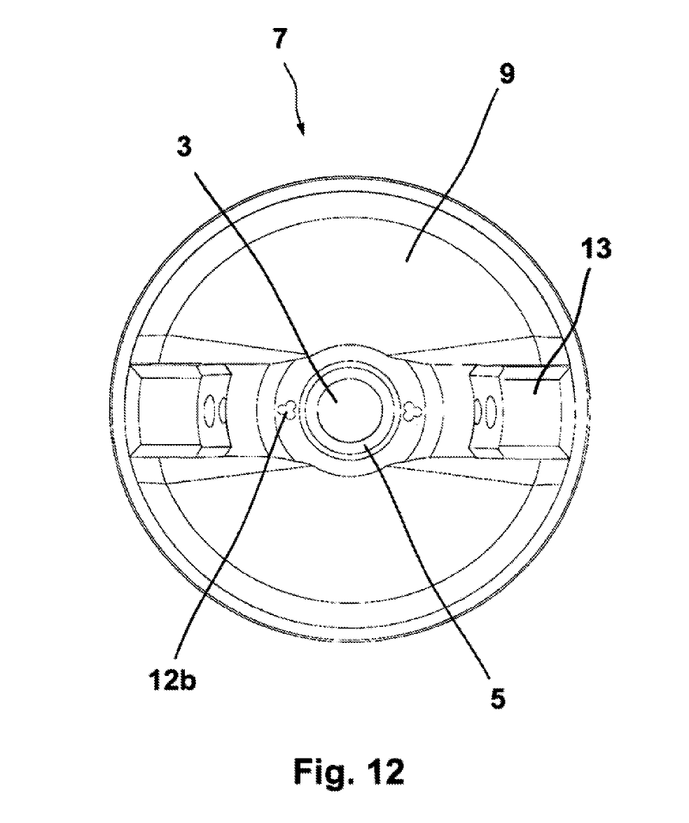

In the variant according to FIG. 12, only two control openings 12b are provided instead of four control openings, wherein these two control openings are realized even more irregular than in the above-described embodiments. In a top view or outline, they approximately have the shape of a three-leaf clover. The two control openings 12b are provided adjacent to the horns 13, 14 on the cover plate 9 of the air cap 7, namely adjacent to the paint nozzle 3 and the air ring nozzle 5.

Special fluidically optimized channels for the horn air are created with the above-described cross-sectional shapes of the horn air nozzles. It would naturally also be possible to realize other cross-sectional shapes and combinations thereof.

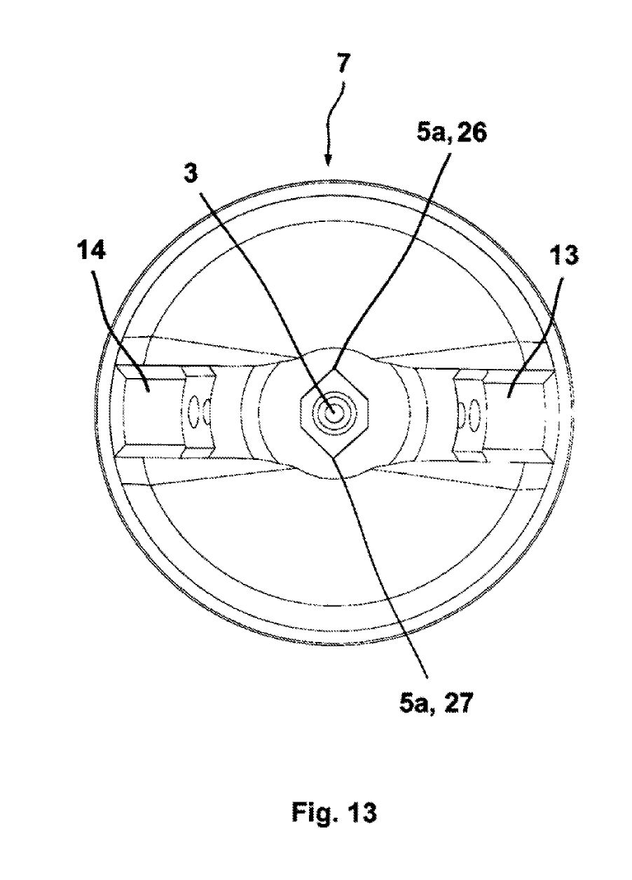

FIG. 13 shows a variant of an air cap 7, in which the air ring nozzle extending around the paint nozzle 3 is not conventionally realized cylindrically. In a top view, the air ring nozzle 5a has an approximately hexagonal shape with two peaks 26, 27 in this case. The peaks 26, 27 face away from the horns 13, 14 in this embodiment. In another embodiment, the peaks 26, 27 could also face the horns 13, 14.

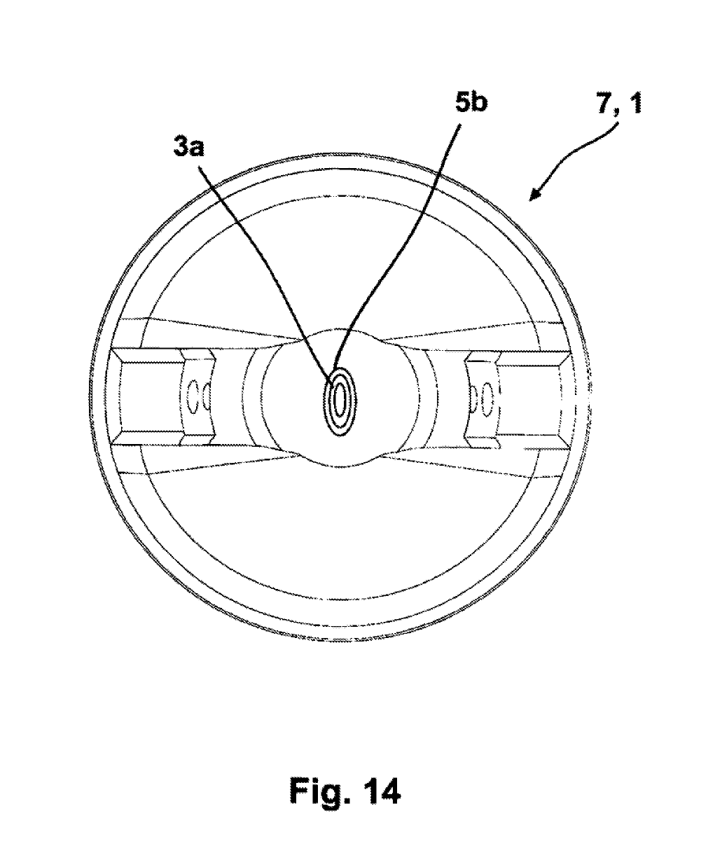

FIG. 14 shows another air ring nozzle 5b that has a strictly oval shape in a top view in combination with a likewise shaped paint nozzle 3a on an air cap 7 of a nozzle head 1.

In the last two variants, the round jet is pre-formed due to the special shaping in such a way that less horn air than usual is required for the formation of the broad jet.

Other embodiments of the nozzle head with a different air cap or even without [an] air cap are conceivable; in the context of the invention, the non-cylindrical openings in the nozzle head are of essential importance.

The nozzle head 1a illustrated in FIG. 15 forms part of a special high-pressure gun that is ideal for processing large quantities of highly viscous materials because it operates with auxiliary air atomization. The nozzle head 1a features a so-called air nozzle 200 and a so-called preliminary nozzle 201 that engages into the air nozzle 200 by means of an attachment 202. These components can be screwed on the body of the not-shown spray gun by means of a so-called air nozzle ring 203. In such spray guns, all air-conveying and material-conveying openings or nozzles are usually realized cylindrically. The material is discharged from the central nozzle 3b in the form of a flat jet and subsequently shaped into a round jet. It is proposed to realize at least one of the openings 300a, 300b or air-conveying or material-conveying nozzles, particularly the horn air nozzles 300a, in a non-cylindrical fashion. Due to this measure, special effects can also be realized in this case.

Arbitrary combinations of the described nozzle variants naturally are possible and may lead to particularly advantageous spraying results.

All combinations of cylindrical and non-cylindrical nozzles are conceivable in dependence on the desired work result and fall under the scope of the present invention.

The invention naturally is not limited to the above-described nozzle heads. It can also be advantageously utilized in other nozzle heads.

The proposed non-cylindrical nozzles naturally can be produced in a particularly simple fashion in nozzle heads or parts of nozzle heads that are made of plastic, particularly injection-molded. In nozzle heads that are entirely or partially made of metal (usually special steel), non-cylindrical nozzles can be realized by means of lost-wax casting or with the aid of inserts.

In other embodiments, the air nozzle/air ring nozzle may also be directly attached, clipped or screwed on the paint nozzle or installed or mounted thereon in a different way. The air nozzle and the paint nozzle may also be realized in one piece.

The entire nozzle device could be directly connected to a gun body with or without additional carrier device.

In another embodiment, the nozzle device respectively is directly connected to the compressed air network and a material supply.

In another embodiment, the nozzle device may also represent part of the air supply or the material supply.

The external shape of the nozzle device may also have arbitrary geometric shapes in the circumferential direction; in one particular embodiment, the entire spray device may have arbitrary geometric shapes.

The openings for the jet formation, as well as the horn air nozzles or horn outlet openings, do not necessarily have to be provided in projecting horns, but may also be arranged, for example in the plate 9, in lateral elevations, in tubes or in a circumferential ring around the plate.

The number of openings in the horns, as well as for the jet formation, is basically arbitrary; several openings may be combined in segments and arranged, for example, in areas that lie opposite one another (90 degrees, 45 degrees, 30 degrees, . . . ). In this case, particular jet shapes can be realized by means of individual openings, several or many openings.

Due to the described and other conceivable fluidically optimized nozzle openings, the energy of the compressed air can be more optimally utilized, the jet can be formed in a superior fashion and the atomization can be improved. In addition to achieving finer droplets, this also makes it possible to improve the droplet distribution in the jet and to realize a more uniform droplet distribution center. It is likewise possible to reduce the dependence of the jet on other parameters such as, e.g., the supply pressure, the material viscosity and manufacturing tolerances, and to diminish the noise by reducing the discharge speed and the compressed air demand.

1-48. (canceled)

49. A nozzle head for a spray device, comprising:
a central material nozzle;
an air ring nozzle surrounding said material nozzle; and
at least two laterally projecting horns, into which at least one horn air nozzle is respectively incorporated,
wherein at least one nozzle has a non-cylindrical shape.

50. The nozzle head according to claim 49, further comprising a material conveying needle.

51. The nozzle head according to claim 49, wherein the at least nozzle with a non-cylindrical shape is a horn air nozzle.

52. The nozzle head according to claim 49, wherein the air ring nozzle has a non-cylindrical shape.

53. The nozzle head according to claim 52, wherein the at least one air ring nozzle of non-cylindrical shape is combined with the at least one horn air nozzle that has a cylindrical shape.

54. The nozzle head according to claim 49, further comprising at least one control opening with a non-cylindrical shape is provided adjacent to the air ring nozzle.

55. The nozzle head according to claim 49, wherein the at least one of the non-cylindrical nozzles is mounted on the nozzle head by means of an insert.

56. The nozzle head according to claim 49, wherein at least one of the nozzles is realized with an elliptical cross section.

57. The nozzle head according to claim 49, wherein at least one of the nozzles is realized with a drop-shaped oval cross section.

58. The nozzle head according to claim 49, wherein at least one of the nozzles is realized with an approximately lunulate cross section.

59. The nozzle head according to claim 49, wherein at least one of the nozzles has a cross section or outline that approximately resembles the number 8.

60. The nozzle head according to claim 49, wherein at least one of the nozzles approximately has the cross section of a three-leaf clover.

61. The nozzle head according to claim 49, wherein at least one of the nozzles approximately has the cross section of a rectangle, particularly a square.

62. The nozzle head according to claim 49, wherein a flow surface of at least one of the nozzles has a corrugated, nubby, fluted or spiral-shaped design or is realized in a different way.

63. The nozzle head according to claim 62, wherein at least one of the nozzles features at least one flow-conveying groove.

64. The nozzle head according to claim 63, wherein the groove is a longitudinal groove.

65. The nozzle head according to claim 49, wherein at least one horn features only a single horn air nozzle.

66. The nozzle head according to claim 49, wherein at least one horn features two horn air nozzles.

67. The nozzle head according to claim 49, characterized by the fact that at least one horn features three horn air nozzles.

68. The nozzle head according to claim 67, characterized by the fact that the horn air nozzles are realized with different sizes.

69. The nozzle head according to claim 49, wherein the nozzles at least approximately have the same internal size anywhere in the longitudinal direction.

70. The nozzle head according to claim 49, wherein the internal size of the nozzles is widened or tapered in the longitudinal direction.

71. The nozzle head according to claim 49, wherein several nozzles are segmentally arranged in a combined fashion.

72. The nozzle head according to claim 49, wherein the horn air nozzle or the horn air nozzles are respectively arranged in areas that do not have a horn shape.

73. The nozzle head according to claim 49, wherein at least one of the non-cylindrical extends at least approximately in the longitudinal direction of the nozzle head.

74. The nozzle head according to claim 49, wherein at least one of the non-cylindrical nozzles extends at least approximately transverse to the longitudinal direction of the nozzle head.

75. The nozzle head according to claim 66, wherein several nozzles extend at least approximately at the same angle referred to the spray jet direction.

76. The nozzle head according to claim 66, wherein several nozzles extend at different angles referred to the spray jet direction.

77. The nozzle head according to claim 49, wherein the nozzles are recessed into the nozzle head or a component connected thereto.

78. The nozzle head according to claim 49, wherein at least one nozzle is connected to the nozzle head or to a component connected thereto by means of an insert.

79. The nozzle head according to claim 77, wherein the component is an air cap of a paint spray gun.

80. The nozzle head according to claim 49, wherein a material-conveying needle is provided and realized in the form of a solid body.

81. The nozzle head according to claim 49, characterized by the fact that a hollow needle with a material-conveying opening is provided.

82. The nozzle head according to claim 81, wherein the opening in the hollow needle has a non-cylindrical shape.

83. The nozzle head according to claim 81, wherein the opening is connected to a material-containing device.

84. The nozzle head according to claim 83, wherein the opening is connected to compressed air or to a vacuum.

85. The nozzle head according to claim 80, wherein the needle is seated in the nozzle head with a press fit.

86. The nozzle head according to claim 49, wherein one or more control nozzles are provided.

87. The nozzle head according to claim 49, wherein the air ring nozzle surrounds at least one material-conveying component.

88. The nozzle head according to claim 87, wherein the air ring nozzle is attached, clipped or screwed on the material-conveying component or connected thereto in a different way.

89. The nozzle head according to claim 87, wherein the air ring nozzle is realized in one piece with the material-conveying component.

90. The nozzle head according to claim 49, wherein the nozzle head is at least sectionally made of plastic, particularly injection-molded of plastic.

91. The nozzle head according to claim 90, wherein the nozzle head features an air cap that is made of plastic.

92. The nozzle head according to claim 90, wherein a nozzle-guiding insert in the nozzle head is made of plastic.

93. The nozzle head according to claim 91, wherein the nozzle head is otherwise made of metal, particularly of steel.

94. The nozzle head according to claim 49, wherein the nozzle head is directly connected to the body of the spray gun.

95. The nozzle head according to claim 49, wherein the nozzle head is connected to the body of the spray gun by means of a carrier device.

96. The nozzle head according to claim 49, wherein the nozzle head is provided on a pneumatic spray gun.

97. The nozzle head according to claim 49, wherein the nozzle head is provided on a hydrostatic spray gun.

98. The nozzle head according to claim 49, wherein the nozzle head is provided on a combined pneumatic/hydrostatic spray gun.
